(19) United States
(12) Patent Application Publication
(10) Pub. No.: US 2005/0136163 A1
(43) Pub. Date: Jun. 23, 2005

(54) Orifice modifier

(75) Inventors: Craig Luther Evans, Green Bay, WI (US); Gary Lee Wied, Seymour, WI (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor-Breyers Ice Cream

(21) Appl. No.: 10/742,985

(22) Filed: Dec. 22, 2003

(51) Int. Cl. B28B 3/20

(52) U.S. Cl. 426/516

(57) ABSTRACT

An orifice modifier which can be added to a frozen confection-dispensing outlet and which can impart, ideally without human manipulation, a desired shape to the dispensed product. In a preferred embodiment, the orifice modifier is, or includes, one or more edges or borders which impose a shape on the dispensing orifice whereby to produce a product with a desirable pattern. Preferably, the edges or borders include a serrated or other pattern. In a particularly preferred embodiment, a mechanism is provided for moving the one or more borders while the product is being dispensed. If the orifice modifier is moved during dispensing of the product, an especially esthetically pleasing pattern is formed in the emerging ice cream. Such patterns can be captured for the final product by refrigeration.

### BACKGROUND OF THE INVENTION

Ice cream and other frozen confections have long been favored dessert and snack foods among consumers. Although largely considered indulgence foods, they often provide valuable nutrients, e.g., calcium, as well. Ice cream sandwiches are a popular vehicle for serving and selling frozen confections. Typically the products comprise ice cream sandwiched between two wafers.

Frozen confection manufacturers often seek to improve their products by providing additional features to attract consumers. While it is believed that ice cream sandwiches are appreciated largely for their organoleptic properties, some manufacturers have differentiated their products by changes in their appearance.

Silhouette Brands Inc. of New York, N.Y. sells the Silhouette® low fat ice cream sandwich product called “The Skinny Cow.” The Skinny Cow includes a braided low fat ice cream design which is visible along the periphery of the sandwich.

Vendors of soft ice cream products, such as ice cream cones, are well known for their ability to dispense their products by hand from machines in a way such that different patterns of ice cream on the cone can be made.

Various patents disclose methods of dispensing ice cream and/or ice cream sandwiches or methods for shaping a confectionery product. These include Price et al. U.S. Pat. No. 4,612,852, Kennedy et al. U.S. Pat. No. 5,493,957, Grenier U.S. Pat. No. 4,793,279, Tucker et al. U.S. Pat. No. 6,326,046 and Beer U.S. Pat. No. 4,828,854.

It would be desirable to provide an automated mechanism for imparting to ice cream and other frozen confections, especially to ice cream sandwiches, a braided or other design.

### SUMMARY OF THE INVENTION

The present invention is directed to an orifice modifier which can be readily imposed upon a frozen confection-dispensing outlet and which can impart, ideally without further human manipulation, a desired shape to the dispensed product. In a preferred embodiment, the orifice modifier is, or includes, one or more edges or borders which impose a shape on the dispensing orifice whereby to produce a product with a desirable pattern. Preferably, the edges or borders include a serrated or other pattern. In a particularly preferred embodiment, a mechanism is provided for moving the one or more borders while the product is being dispensed. If the orifice modifier is moved during dispensing of the product, an especially esthetically pleasing pattern is formed in the emerging ice cream. Such patterns can be captured for the final product by refrigeration. The motion imparted to the borders is preferably rectilinear.

The orifice modifier of the invention is ideally attached to or is otherwise associated with the dispensing end of an extruder. For example, an adapter which includes the orifice modifier in fluid communication with the dispensing opening of the extruder may be used to attach the orifice modifier, permanently or temporarily, to the dispensing end of the extruder. The adapter may extend from a frame to which the orifice modifier is attached or forms a part. The adapter may take the form of a square tube which receives the dispensing end of the extruder. The orifice modifier frame may be held onto the end of the extruder by suitable means such as a thread associated with both the extruder and the orifice modifier frame and a nut which is tightened on the thread to retain the orifice modifier on the extruder end.

The orifice of the orifice modifier may be provided with a variety of patterns for imparting shapes to the frozen confection. The orifice of the orifice modifier may have a different shape from that of the dispensing orifice of the extruder. Most preferably, the orifice modifier takes the form of four borders or edge pieces forming a periphery and one or more openings (orifices) in the center. The openings will be other than circles, whereby to impart a special shape to the confection. Along the edge(s) of the opening may be a variety of patterns defined by the borders such as spikes, notches and triangles, which will assist in imparting the design to the frozen confection or other viscous liquid. The edges preferably have inwardly extending projecting parts, such as prongs, tines, triangles, spurs, teeth, tongues, etc.

The invention is also directed to a method of dispensing a viscous product, especially a frozen confection, by urging the product through the orifice modifier of the invention, which imposes a pattern on the product. Most preferably, the orifice modifier is subjected to a movement during dispensing of the product to create the pattern in the product.

While the invention finds particular use in dispensing of ice cream and other frozen confections, it is anticipated that it will also find use in the dispensing of other viscous products.

For a more complete understanding of the above and other features and advantages of the invention, reference should be made to the following description of the preferred embodiment.

### BRIEF DESCRIPTION OF THE DRAWINGS

FIG. 1 is a bottom plan view of an apparatus according to the invention.

FIG. 2 is a perspective view of the apparatus of FIG. 1.

FIG. 3 is an exploded perspective view of an ice cream sandwich made in accordance with the invention.

FIG. 4 is a perspective view of the ice cream sandwich of FIG. 3, fully assembled, made in accordance with the invention.

FIG. 5 is a side elevational view showing the extruder end and the frame of the orifice modifier in which the extruder end is received.

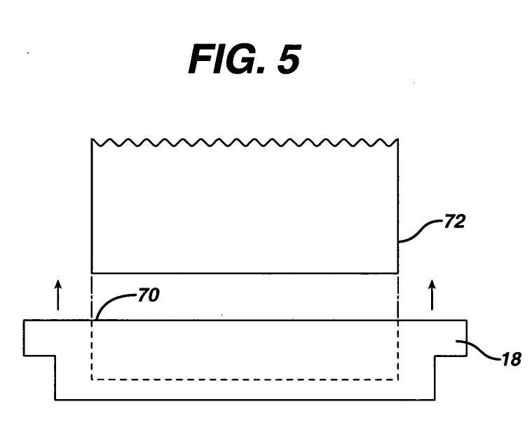

### DETAILED DESCRIPTION OF THE INVENTION

The invention may be employed in the preparation of various frozen confections, especially so called ice-cream sandwiches wherein a frozen confection is sandwiched between two wafers. Machines are available from various vendors to produce ice-cream sandwiches. These so called “cookie sandwich machines” are available from vendors such as Osgood Industries, Inc. of Oldsmar Fla., Norse Dairy Systems of Columbus, Ohio, GRAM Equipment of Tampa Fla., and Tetra Pak Hoyer of Lake Geneva, Wis.

Dispensing of the frozen confection in the cookie sandwich machine or other apparatus is generally through a tube of an extruder. Means are typically employed to pump or push the confection through the extruder. At the end of the extruder is an orifice through which the product exits the extruder. The orifice may be round, square, rectangular or some other shape. Typically, the apparatus will be oriented such that the orifice will open downwardly.

In accordance with one aspect of the invention, adapter housing 18 is fit onto the orifice-end of the extruder. The fit should be snug, but loose enough to permit removal for cleaning. In this respect, the adapter housing may include a sleeve which fits snuggly within the outer circumference of the extruder or in which the extruder 72 is accommodated. If desired, a threaded bar (not shown) may be attached to the orifice modifier at one end, e.g., at bearing blocks 19, and to the extruder at the other. A nut (also not shown) may be used to tighten the connection and to retain more securely the orifice modifier on the extruder end. The adapter housing or parts thereof, especially bearing blocks 19, may be made of a plastic such as Delcrin® available from DuPont. The eccentric 50, the drive plate 52, opposing drive plate 84, the combs, shaft 53 and crank 55 are all preferably made from stainless steel or other metal suitable for food contact.

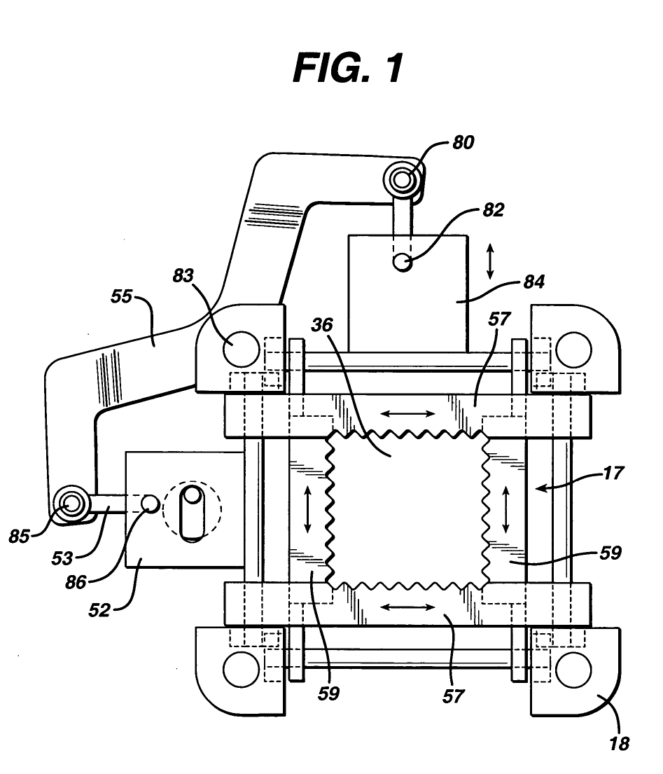

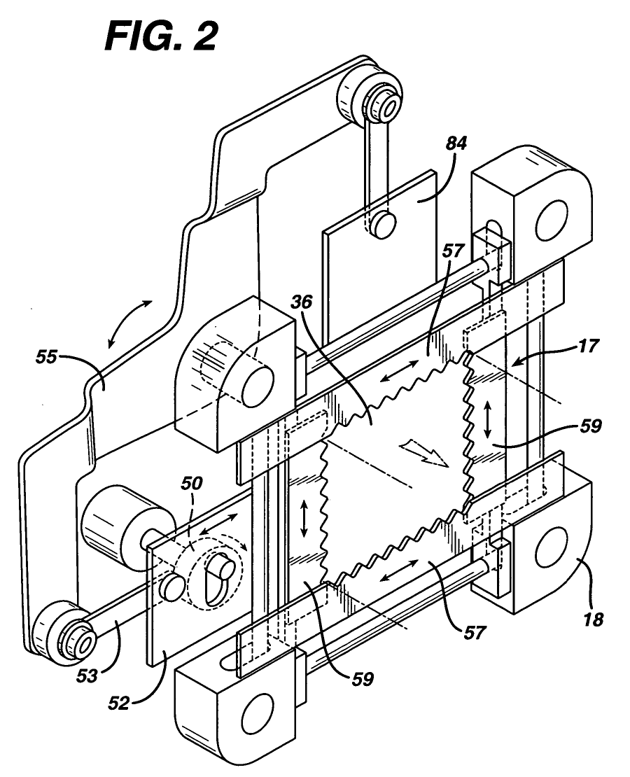

Orifice 36 of orifice modifier 17 preferably is defined by two pairs 57, 59 of borders. Pair 57 extends and reciprocates in the directions shown by the arrows in FIGS. 1 and 2. Pair 59 also extends and reciprocates in the directions shown by the arrows, which are generally perpendicular to those of pair 57. Each of borders 57 extend along a rectilinear axis whereas each of borders 59 extend along a rectilinear axis generally perpendicular to those of borders 57. The borders are preferably made of stainless steel or other metals.

In operation, with extruder orifice 36 facing downwardly, both pairs of borders 57 and 59 are situated, and reciprocate in a horizontal plane.

Often it will be advantageous for the borders to include a serious of regularly repeated notches with a predefined and precisely cut profile, as seen in the borders of FIGS. 1-2.

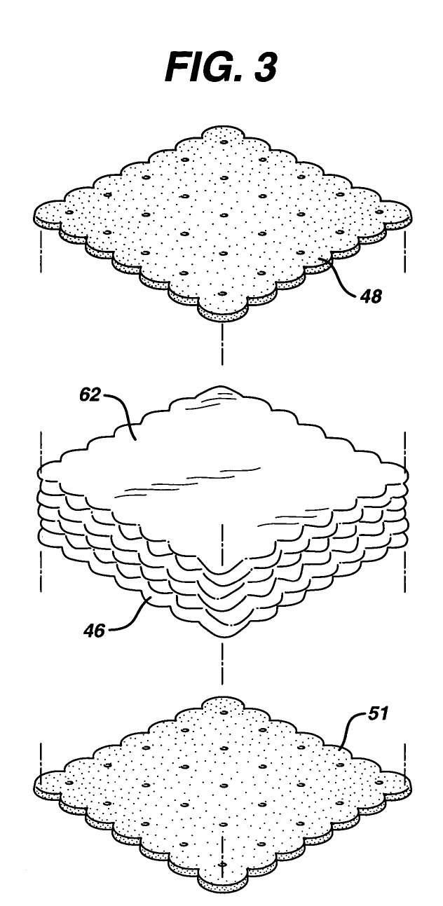

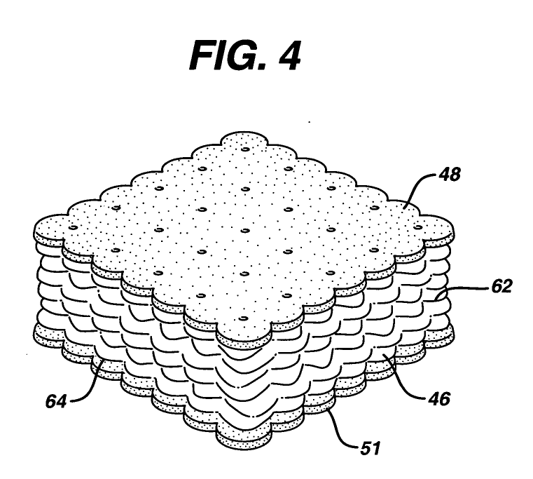

As will be apparent especially from FIGS. 1-2, various shapes for the central orifice of the orifice modifier are possible. It has been found that it is possible to impart various patterns to the dispensed viscous fluid, e.g., no or low fat ice-cream, depending on the arrangement of the centrally disposed orifice of the orifice modifier. For example, depending on speed and the shape of the border or edge, patterns such as woven wicker patterns or wavy patterns may be formed in the frozen confection. Preferably, the borders are reciprocated as the ice-cream is dispensed. In this way, the braided design shown at the periphery of low fat ice-cream sandwich 46 (see FIGS. 3 and 4) can be obtained. Sandwich 46 comprises wafers 48 and 51 between which is disposed ice-cream 62 which can be seen from the periphery to be divided into braids 64. In accordance with the invention, such braids can be created by machine through the use of the orifice modifiers.

The movement preferably imparted to the orifice modifier during dispensing of the confection is preferably reciprocation. As illustrated in FIGS. 1 and 2, a scotch yoke can be employed, although other arrangements and components will be apparent to those skilled in the art, e.g., an air cylinder, crank arm, etc. This can be effected by a motor which drives eccentric 50 which in turn engage first drive plate 52 which drives reciprocating combs 57, as well as shaft 53 which drives crank 55 and second drive plate 84 which reciprocates combs 59. Movement of plates 52, 84 and crank arm 55 involves pivots 86, 85, 83, 80 and 82 as seen in FIGS. 1 and 2.

In operation, ice-cream or other frozen confection is pumped through an extruder through an extruder orifice and then through orifice 36 of orifice modifier 17. While the frozen confection is being pumped through the extruder, orifice modifier 17 is preferably being reciprocated via the motor/eccentric/crank mechanism. The orifice modifier has orifice 36 in the configuration shown in FIGS. 1 and 2 or in another configuration as chosen by the operator.

A pre-determined amount of frozen confection is pumped through orifice 36 and onto cookie wafer 51. Thereafter, second cookie wafer 48 is placed atop the frozen confection in a manner known in the art. The result is a braided pattern as seen in FIG. 4 along the periphery of the ice cream sandwich, or some other pattern as is chosen, e.g., by selecting another of the comb or rakes and/or by choosing different movement parameters therefor. Instead of pumping a pre-determined amount of frozen confection each time, frozen confection may be pumped continuously and cut by a heated wire across a plane parallel to that of the cutting disk and slightly below. To facilitate cutting of the frozen confection, it may be desirable to incline the dispensing end of the extruder a few degrees away from the vertical. In such case, of course, the adapter will also be so inclined since it fits on the inclined dispensing end of the extruder.

Most preferably, one of the combs of the orifice modifier is flat and flush on the end; no projections should be permitted. The other comb is spaced slightly from the end of the adapter to accommodate the first comb so that the combs do not interfere with each other when in motion. The cutting wire, if used, should pass along the face of the outer border as closely as possible.

Preferably the motion imparted to the borders is a continuous one. Continuous in this context does not foreclose change in direction. The motion imparted is preferably reciprocation; changes in speed such as speeding up and slowing down, on a rhythmic basis, one cycle per sandwich, could be employed.

Nothing should project beyond the end of the bottom comb, or the movement of the wire may be impeded.

The apparatus, then, used in the invention to extrude the ice cream, low fat ice cream, no fat ice cream, other frozen confection or, indeed, other viscous liquid, may essentially include three pieces, a stationary piece including the extruder tube and the bearings, a drive unit (motor, eccentric and crank) and reciprocating pieces.

It will be appreciated that the invention provides an easy way to impart braiding or other designs to frozen confections by simple adaptation of existing technology. Indeed, it is believed that the invention can be used for other viscous liquids (liquid at processing temperature) such as butter, margarine and other spreads, cream cheese, hand creams and soaps and other detergent bars.

Where the orifice defined by the borders is essentially square, as illustrated, an essentially square ice cream sandwich results. Other cross sections such as triangular cross sections can be employed for the orifice modifier of the invention. In such case, the sandwich produced by here be triangular in top and bottom plan views.

To avoid separation of fat, so called “buttering out” as a result of the shear experienced by the frozen confection during processing, the invention is most advantageously used on ice cream and other frozen confections having about 12 wt. % fat or less. That is, frozen confections having 0% fat, 0.5 wt. % fat and up to about 12 wt % and ranges and levels of fat in between would preferably be utilized in the invention.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. An apparatus for imparting shape to a viscous fluid comprising an orifice modifier defining an orifice with at least first and second borders and at least one driver associated with said orifice modifier, said one or more drivers being adapted to impart motion to said first and second borders in different directions.

2. The apparatus according to claim 1 wherein said first and second borders are essentially perpendicular to each other.

3. The apparatus according to claim 1 wherein said motion imparted by said one or more drivers is a reciprocating motion.

4. The apparatus according to claim 1 wherein the apparatus contains as the viscous fluid which comprises a frozen confection.

5. The apparatus according to claim 1 wherein at least one of said drivers comprises a motor, a crank and an eccentric.

6. The apparatus according to claim 1 wherein one or more of said borders is in the shape of a rake or comb.

7. The apparatus of claim 1 in combination with an extruder, the extruder having an opening in alignment with the orifice of the orifice modifier.

8. The apparatus of claim 1 wherein one or more of said borders extend along a rectilinear axis.

9. The apparatus of claim 8 wherein said borders comprise a first pair of reciprocating combs or rakes on opposite sides of said orifice and a second pair of combs or rakes on opposite sides of said orifice and generally perpendicular to said first pair.

10. A process for imparting shape to a viscous fluid comprising urging said viscous fluid through an orifice with at least first and second borders and at least one driver associated with at least one of said borders, said one or more drivers imparting motion to said first and second borders in different directions while viscous fluid is flowing through said orifice.

11. An apparatus for imparting shape to a viscous fluid comprising an orifice modifier defining an orifice with at least first and second borders and at least one driver, said driver being adapted to impart motion to said first border while said second border remains stationery.

12. The apparatus according to claim 11 wherein said first and second borders are essentially perpendicular to each other.

13. The apparatus according to claim 11 wherein said motion imparted by said one or more drivers is a reciprocating motion.

14. The apparatus according to claim 11 wherein the apparatus contains a viscous fluid which comprises a frozen confection.

15. The apparatus according to claim 11 wherein said driver comprises a motor, a crank and an eccentric.

16. The apparatus according to claim 1 wherein one or more of said borders is in the shape of a rake or comb.

17. The apparatus of claim 11 in combination with an extruder, the extruder having an opening in alignment with the orifice of the orifice modifier.

18. The apparatus of claim 11 wherein one or more of said borders extend along a rectilinear axis.

19. The apparatus of claim 18 wherein said borders comprise a first pair of combs or rakes on opposite sides of said orifice and a second pair of combs or rakes on opposite sides of said orifice and generally perpendicular to said first pair.

20. A process for imparting shape to a viscous fluid comprising urging said viscous fluid through an orifice with at least first and second borders and at least one driver associated with said first border, said one or more drivers imparting motion to said first border as said second border is maintained stationery while viscous fluid is flowing through said orifice.

21. The process according to claim 20 wherein said viscous fluid is a frozen confection.

22. The process according to claim 21 wherein said frozen confection comprises up to about 12 wt. % triglyceride fat.

23. The process according to claim 10 wherein said viscous fluid is a frozen confection.

24. The process according to claim 10 wherein said frozen confection comprises up to about 12 wt. % triglyceride fat.
